(19) United States
(12) Patent Application Publication
(10) Pub. No.: US 2005/0177776 A1
(43) Pub. Date: Aug. 11, 2005

(54) Apparatus and method for monitoring software module state in a system using an embedded multitasking OS

(76) Inventors: Jin-Oh Kim, Suwon-si (KR); Byung-Gu Choe, Seoul (KR); Yong-Seok Park, Yongin-si (KR)

Correspondence Address: Robert E. Bushnell;Suite 300, 1522 K Street, N.W., Washington, DC, 20005, US

(21) Appl. No.: 11/004,850

(22) Filed: Dec. 7, 2004

(30) Foreign Application Priority Data
Jan. 27, 2004 (KR) 2004-5153

(51) Int. Cl. G06F 11/00

(52) U.S. Cl. 714/38

(57) ABSTRACT

The apparatus and method for monitoring the software module state of the embedded multitasking operating system in a system using the embedded multitasking operating system according to the invention sequentially records the state information of the software modules in the state recording range of the hardware logic, sequentially reads the state information of the software modules from the state recording range, and displays the state information so that the user can easily recognize the same. As a result, the state information of the software modules can be monitored and inspected independent from the operation of the software modules of the operating system, and thus the state of the software modules or the operating system can be inspected in any exceptional software-associated situations.

### CLAIM OF PRIORITY

This application makes reference to, incorporates the same herein, and claims all benefits accruing under 35 U.S.C. §119 from an application for APPARATUS AND METHOD FOR MONITORING SOFTWARE MODULE STATE IN SYSTEMS USING EMBEDDED MULTITASK OPERATING SYSTEM earlier filed in the Korean Intellectual Property Office on 27 Jan. 2004 and there duly assigned Serial No. 2004-5153.

### BACKGROUND OF THE INVENTION

1. Field of the Invention

The present invention relates to an embedded multitasking operating system, and more particularly, to an apparatus and method for efficiently monitoring panics in a kernel or the internal state of a software module of an embedded multitasking operating system in a system using the embedded multitasking operating system.

2. Description of the Related Art

In general, an operating system (hereinafter will be referred to as “OS”) used in an embedded system includes a kernel or a software module functioning as a core element of the OS. While the OS is a concept more comprehensive than the kernel, they will be used together in the same meaning.

Although different more or less according to adopted OS, the kernel performs following functions:

First, memory management (e.g., support an imaginary memory and protect a memory) in a system; second, interrupt and timer management; third, process/task scheduling; and fourth, bus or controller initialization and management.

The foregoing functions constitute core elements of an OS and manage resources within a system so that software modules operating based upon the OS can effectively provide services. Most of these resources need the support from hardware. Therefore, realizing the kernel is generally associated with hardware in execution.

Since those software modules for managing services provided by the embedded system are designed to operate in the OS containing such a kernel, the OS is required to constantly maintain a normal operation state regardless of the operation state of an upper service software (i.e., a software operating based upon the OS). The OS is also required to have an ability of rapidly providing management in the event of any abnormal problems.

However, this kernel directly manages a large number of hardware parts together with many and various software modules, and thus is constantly exposed to abnormal operations. In case of abnormal operation of a software module that is not sufficiently verified in stability, the kernel itself may show abnormal operation.

In order to prevent the foregoing problems, the kernel has a function capable of restricting resource access according to mode types, classified into supervisor and user modes. However, a software module such as a device driver which directly accesses hardware may positively directly influence the kernel since it generally operates in the supervisor mode.

Hereinafter an operation for monitoring the status of a kernel software in an OS of the earlier art will be described with reference to appended FIGS. 1 and 2.

FIG. 1 illustrates the operating status between kernel software modules 20a to 20c of a conventional OS 10 and the relation between software modules for monitoring the operating status of the kernel software modules 20a to 20c.

As shown in FIG. 1, the conventional OS 10 may include the plurality of kernel software modules 20a to 20c, a scheduler 30 and a status monitoring software module 40. Herein, the status monitoring software module 40 includes a status inspection part 41 and a status output part 42, the kernel software modules 20a to 20n mean all software modules operating in the kernel, and the output status information of the software modules via the output part 42 can be displayed by an external display 101.

As shown in FIG. 1, the conventional OS 10 is operated separately in a supervisor mode and a common user mode.

Since the OS can directly use all resources of a system in the supervisor mode, all software modules do not operate in the supervisor mode, but some software modules requiring direct management of resources operate in this module. Herein the terminology “resources” mean hardware parts such as a memory.

Those software modules operating in the common user mode are restricted by the kernel so that they cannot directly connect to the resources such as hardware. Therefore, the software modules operating in the common user mode rarely give fatal influence to the system. However, since those software modules called device drivers directly control hardware while operating in the supervisor mode, they can cause severe abnormal status to the system.

As a consequence, most OS's may have a software module for monitoring such status. This software module is also under the control of the kernel since it operates in the kernel.

As shown in FIG. 1, the OS 10 has a scheduler 30, that is, a software module functioning as a core element to manage the software modules. The scheduler 30 arbitrates several types of kernel software modules 20a to 20n so that they can perform their functions. The kernel software modules 20a to 20n referred herein include all software modules operating in the kernel.

The scheduler 30 distributes predetermined times to the respective software modules according to self-algorithm so that all the software modules in the OS 10 can operate normally.

The respective kernel software modules 20a to 20n are required to perform their functions within the times distributed by the scheduler 30. After termination of the execution times of the kernel software modules 20a to 20n which are currently operating, the scheduler 30 transfers the right of using the resources to next ones of the kernel software modules 20a to 20n so that the next kernel software modules 20a to 20n can operate.

This process is repeated so that all the software modules in the kernel can be operated normally, and will be continuously repeated as long as the system is operated normally.

There is a status monitoring software module 40 for periodically monitoring the status of the software modules in the kernel 10 and informing the software status to the outside. The software module 40 can be controlled by the scheduler 30 as other kernel software modules 20a to 20n. A user can confirm the kernel status from information displayed on the display 10 via the status monitoring software module 40.

Hereinafter a conventional method for monitoring software module state corresponding to the conventional operation of the OS for monitoring software module state will be described with reference to FIG. 2.

FIG. 2 is a process flowchart illustrating a conventional method for monitoring kernel software status.

As shown in FIG. 2, the scheduler 30 provides software modules, that is, kernel software modules 20a to 20n and status monitoring software modules 40 under the control with opportunities to be equally operated. According to a preset algorithm, the scheduler 30 determines some of the software modules 20a to 20n and 40 to be operated after currently operating ones of the software modules 20a to 20n and 40.

After termination of times distributed to the currently operating ones of the software modules 20a to 20n and 40, the scheduler 30 temporarily stops the currently operating ones of the software modules 20a to 20n and 40, and operates those ones of the software modules 20a to 20n and 40 to be operated next and allocates execution times to the next operating ones of the software modules 20a to 20n and 40 (S101).

The scheduler 30 judges whether a software module to be operated is the status monitoring software module 40 (S102). If the currently operated software module is the status monitoring software module 40, the scheduler 30 inspects the status of the respective kernel software modules 20a to 20n and 40, and outputs the status information of the inspected kernel software modules 20a to 20n via the external display 100 so that a user can confirm the current status of the kernel software modules 20a to 20n (S103).

However, if it is judged in S102 that the software module to be executed next is any of the kernel software modules 20a to 20n which execute common functions, the scheduler 30 allows corresponding one of the kernel software modules 20a to 20n to execute its own function (S105), and judges whether the corresponding module malfunctions while executing its own function (S106).

If any of the kernel software modules 20a to 20n malfunctions, a system panic occurs so that the system cannot be restored.

However, if the kernel software modules 20a to 20n normally function, the scheduler 30 judges whether all the execution times allocated to the software modules 20a to 20n and 40 are terminated (S104).

If all the allocated execution times are terminated, the scheduler determines some of the software modules to be executed next, and repeats the foregoing process.

Exceptional situations take place because the software modules 20a to 20c in the kernel manage different types of hardware. In this case, if all the resources are occupied by specific ones of the kernel software modules 20a to 20n, the scheduler 30 itself may not properly operate.

In this severe situation, the status monitoring software module 40 does not operate normally so that the user cannot confirm the internal state of the system. Then, since the internal state of the system is not correctly inspected, approaches for solving the problems become difficult.

The primary reason of such a severe problem comes from an erroneously composed software. However, the corresponding software may be additionally composed for services rather than for the kernel itself. Even in this case, it is required to inspect the OS state rapidly to find the problem.

All of the scheduler within the kernel, the kernel software creating the problem and the state-monitoring software module are software. Therefore, the foregoing severe situation can be rarely solved with software modules only, and thus needs the aid of a hardware logic. Since the hardware logic can operate independent from the software modules, the hardware logic can recognize the state of a software only if the hardware logic is properly interfaced with the software.

### SUMMARY OF THE INVENTION

It is, therefore, an object of the present invention to provide an apparatus and method for monitoring the state of software modules in a system using an embedded multitasking Operating System (OS) in which a hardware logic is constituted independent from software modules to monitor the internal state (panic) of the software modules to output the internal state information of the monitored software modules so that a user can easily recognize the internal state information.

It is another object to provide an apparatus and method for monitoring the software module state of the embedded multitasking OS in a system using the OS records the state information of the software modules of the OS in the hardware logic, reads the recorded state information of the software modules via the hardware logic, and displays or presents the read state information.

It is yet another object to provide the state information of the software modules of the OS to be recorded sequentially in the state recording range of the hardware logic and then sequentially read via the hardware logic in response to a state information inspection request from a user so that state information of the software modules of the OS can be monitored and confirmed independent from the operation of the software modules of the OS.

It is still another object to provide an apparatus and method for monitoring the software module state of the embedded multitasking OS in a system using the embedded multitasking OS according to the invention to sequentially record the state information of the software modules in the state recording range of the hardware logic, sequentially read the state information of the software modules from the state recording range, and display the state information so that the user can easily recognize the same.

It is another object to provide the state information of the software modules to be monitored and inspected independent from the operation of the software modules of the OS, and thus the state of the software modules or the OS can be inspected in any exceptional software-associated situations.

It is yet another object to provide a method and apparatus that provides the software and hardware to not influence each other's operation in a system and thus increasing system stability by avoiding severely negative system conditions including hanging or system crashes.

It is another object of the present invention to provide an apparatus and method for monitoring the state of software modules in a system that is easy to implement, cost effective and efficient and yet increase system stability.

According to an aspect of the invention for realizing the above objects, there is provided an apparatus of the invention for monitoring software modules in a multitasking Operating System (OS) in a system using the multitasking OS, including a hardware logic interfaced with the OS, wherein the hardware logic executes the following steps of: (a) determining a record range for recording the state information of the software modules of the OS therein and the size of the record range, and sequentially recording the state information of an operating software module in a corresponding range; and (b) reading and outputting the recorded state information of the software module in response to a state information request event.

Preferably, the OS determines a recording range address, in which the state information of the respective software modules will be recorded at the initialization of the software modules, and the size of corresponding address, and includes a state information record setting module for recording the determined address and the size of the software state information to be recorded in a state information recording range of the hardware logic.

Preferably, the address size is determined according to the size of the state information of the respective software modules of the OS to be recorded in the hardware logic.

Preferably, the OS determines a software module to be operated next from the software modules, upon termination of time allocated to a currently operating software module, operates the determined software module, and allocates an operating time to the determined software module in order to control the schedule of the respective software modules so that an operating software module can record its state information in a software state information recording range of the hardware logic.

Preferably, the currently operating software module records its state information, which is operated last in an execution time allocated to the currently operating software module by the scheduling module, in a state information record range of the hardware logic allocated to the currently operating software module.

Preferably, the hardware logic includes: a state information recording part for recording the state information of a software module of the OS, which is operated based upon the software module state recording range address determined at the initialization of the respective software modules of the OS and the size information of the corresponding address, in a corresponding range; a state information requesting part for providing a key input signal for inspecting the state information of the software modules of the OS recorded in the state information recording part; a state information reading part for reading the state information of the respective software module recorded in the state information recording part and outputting the read state information of the software modules in the form of displayable data upon receiving a state information inspecting request signal from the state information requesting part; and a display for presenting the data corresponding to the output state information of the software modules from the state information reading part.

Preferably, the state information recording part includes: a first recording field for recording the address, in which the state information of the respective software modules of the OS are to be recorded, and the size information about the state information of the respective software modules corresponding to the address; and a second recording field for recording the state information of a corresponding software module according the size information about the state information of the respective software modules of the OS recorded in the first recording field.

Preferably, the first recording field has a range at least the same as the number of the software modules of the OS, the state information of the respective software modules of the OS recorded in the second recording field is recorded in the form of hexa codes.

Preferably, the state information reading part includes a format converting part for converting the state information of a software module read from the state information recording part in the format of displayable data that is easily conceivable by a user.

Preferably, the format converting part converts the state information of the respective software modules of the OS recorded in the state information recording part into at least one format selected from a group including a binary number, decimal number and text message, and presents the converted format via the display.

Preferably, state information reading part sequentially reads the state information of the respective software modules from the state information recording part in a round robin fashion to present the read state information via the display in response to the request signal from the state information requesting part, or the state information reading part sequentially reads the state information of the respective software modules recorded in the information recording part to present the state information of all of the software modules via the display in response to the request signal from the state information requesting part.

Preferably, the display includes at least one of a character LED (light emitting diode) and a character LCD (liquid crystal display).

Preferably, the hardware logic is realized in the form of a Field Programmable Gate Array (FPGA).

According to another aspect of the invention for realizing the above objects, there is provided an apparatus for monitoring software modules in a multitasking Operating System (OS) in a system using the multitasking OS, including: an OS having software modules executing different operations, the OS determining a recording range address for recording state information according to the software modules and the size of the state information recording range, and generating the size information of the determined address and the state information; and a hardware logic interfaced with the OS for (a) recording an address, in which state information according to software modules created from the OS is recorded, and size information for recording the state information in a first range, and sequentially recording the present state information of an operating software module of the OS in a second range corresponding to the address and the state information size information, (b) reading the recorded state information of the software modules, converting the state information into a displayable format, and presenting the converted state information of the software modules via a display in response to a state information request event.

Preferably, the OS includes: software modules for operating different operations; a scheduling module for allocating executing times to the software modules and controlling the execution of the software modules according to the allocated times; and a state information record setting part for determining a record range address, in which the state information according to the software modules is recorded, and the size of the corresponding address at the initialization of the software modules, interfacing the determined address, the size value about the software state information to be recorded and the present state information of the software modules to the hardware logic.

According to further another aspect of the invention for realizing the above objects, there is provided an apparatus for monitoring software modules in a multitasking Operating System (OS) in a system using the multitasking OS, including: a state information recording part for recording the state information of the software modules of the OS in a corresponding range according to a software recording range address determined at the initialization of the software modules of the OS and the size of a corresponding address; a state information requesting part for providing a key input signal for inspecting the state information of the software modules of the OS recorded in the state information recording part; a state information reading part for reading the state information of the respective software modules recorded in the state information recording part and outputting the read state information of the software modules in the form of displayable data upon receiving a state information inspecting request signal from the state information requesting part; and a display for presenting the data corresponding to the output state information of the software modules from the state information reading part.

According to other aspect of the invention for realizing the above objects, there is provided a method for monitoring software modules in a multitasking Operating System (OS) in a system using the multitasking OS, the method including the following steps of: (a) determining a record range for recording the state information of the software modules of the OS therein and the size of the record range, and sequentially recording the state information of an operating software module in a corresponding range; and (b) if a state information request event occurs, reading and outputting the recorded state information of the software module.

Preferably, the recording step includes: recording an address and the size information about the state information of the software modules of the OS in a first recording field, the state information of the software modules being recorded according to the address and the size information corresponding to the address; and recording the state information of a corresponding software module in a second recording field based upon the size information about the state information of the software modules recorded in the first recording field.

Preferably, the range of the first recording field is at least the same as the number of the software modules of the OS, and the state information of the software modules recorded in the second field is recorded in hexa codes.

Preferably, the step of outputting the displayable data includes converting the state information of the software modules read from the state information recording range into one selected from a group including a binary number, decimal number and text message that is easily conceivable by a user.

Preferably, the step of outputting the displayable data includes sequentially reading the state information of the software modules from the state information recording range in a round robin fashion in response to a state information request signal from a user.

According to yet another aspect of the invention for realizing the above objects, there is provided a method for monitoring software modules in a multitasking Operating System (OS) in a system using the multitasking OS, the method including the following steps of: recording the state information of the software modules of the OS in a corresponding range according to a software recording range address determined at the initialization of the software modules of the OS and the size of a corresponding address; upon receiving a key input signal for inspecting the state information of the software modules of the OS, reading the state information of the respective software modules recorded in the state information recording part and outputting the read state information of the software modules in the form of displayable data; and presenting the output data corresponding to the state information of the software modules.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating kernel software modules connected with a state monitoring software module in an OS of a convention embedded multitasking system;

FIG. 2 is a process flowchart illustrating a conventional method for monitoring the state of kernel software modules;

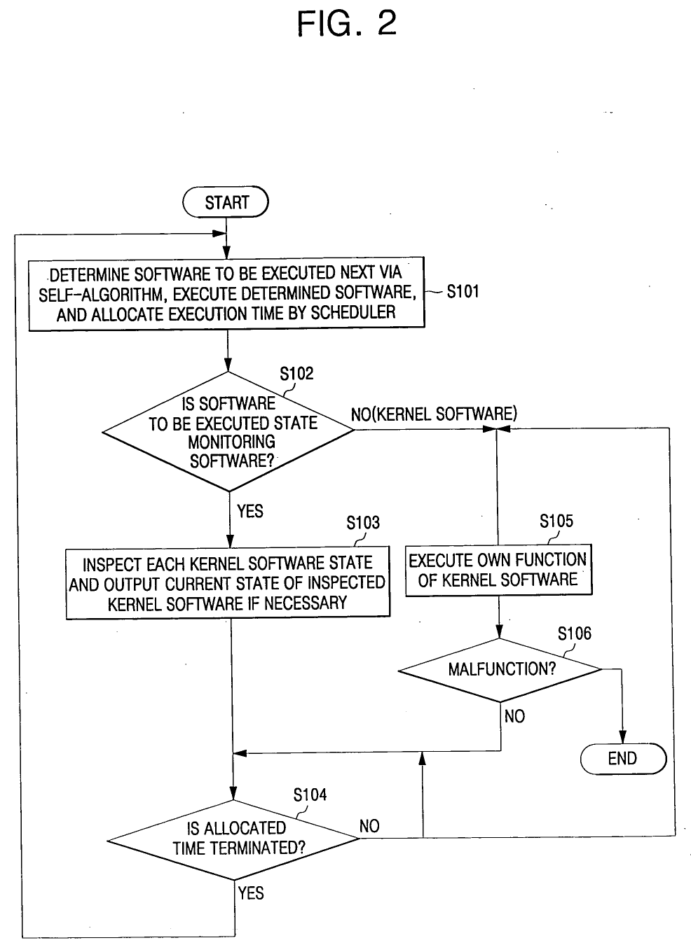

FIG. 3 is a block diagram of an apparatus for monitoring software module state in a system using an embedded multitasking OS according to the present invention;

FIG. 4 is a table illustrating a data structure stored in a state recording block in FIG. 3;

FIG. 5 is a process flowchart illustrating a method for monitoring software module state in a system using an embedded multitasking OS according to the present invention;

FIG. 6 is a block diagram illustrating data flow for determining addresses and sizes according to which the kernel software modules shown in FIG. 4 record their state information in the state recording part;

FIG. 7 is a process flowchart illustrating a method for determining the addresses and sizes according to which the kernel software modules of the invention record their state information in the state recording part;

FIG. 8 is a block diagram illustrating data flow in a hardware logic shown in FIG. 4 in which kernel software modules output state values recorded in a state recording part to an external display in response to a request from a user;

FIG. 9 is a process flowchart illustrating a method for outputting software state values recorded in a state recording part of a hardware logic shown in FIG. 4 to an external display according to the data flow shown in FIG. 8 in response to the request from the user; and

FIG. 10 shows an example of a computer including a computer-readable medium having computer-executable instructions for performing a technique of the present invention.

### DETAILED DESCRIPTION OF THE PREFERRED EMBODIMENTS

Hereinafter an apparatus and method for monitoring software module state of a system using an embedded multitasking OS according to the invention will be described in detail with reference to the accompanying drawings.

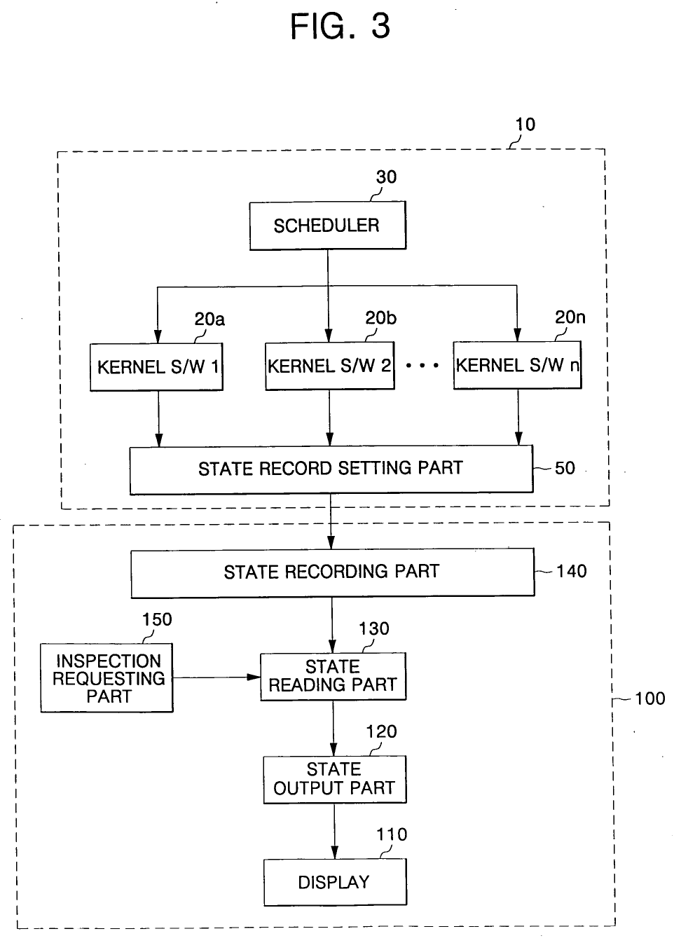

FIG. 3 is a block diagram of an apparatus for monitoring software module state in a system using an embedded multitasking OS according to the present invention.

As shown in FIG. 3, the software module state monitoring apparatus in a system using an embedded multitasking OS according to the present invention is divided into an OS part 10 and a hardware logic 100, in which both parts operate totally independent from each other without any interaction to the operation state.

The OS part 10 includes a scheduler 30, a number of kernel software modules 20a to 20n and a state record setting part 50, and the hardware logic 100 includes a state recording part 140, a state reading part 130, a state output part 120, a display part 110 and an inspection requesting part 150.

The OS part 10 and the hardware logic 100 exchanges information through the state record setting part 50 and the state recording part 140.

While being executed, the kernel software modules 20a to 20n of the OS 10 can record their own state information in mapping areas of the state recording part 140 set by the state record setting part 50. The state recording part 140 can be divided according to the kernel software modules 20a to 20n or according to a method determined in view of the OS 10.

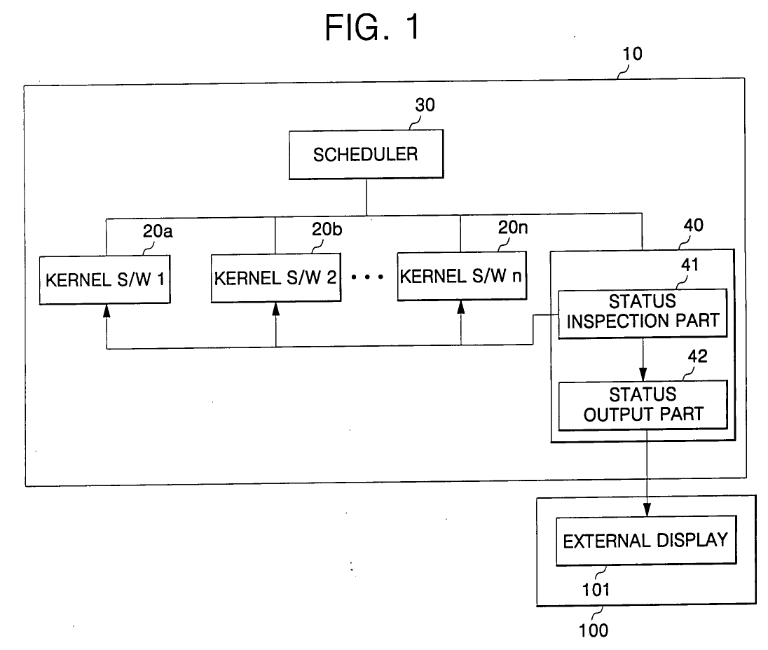

The scheduler 30 and the kernel software modules 20a to 20n will not be described in detail since they are substantially the same components as those of the conventional system shown in FIG. 1. As a technical feature of the invention changed from those of the conventional system shown in FIG. 1, a function for monitoring the state of the kernel software modules 20a to 20n is shifted into the hardware logic 100.

The state record setting part 50 in the OS 10 shown in FIG. 3 sets up record fields and their sizes in order to record the state information of the kernel software modules 20a to 20c in the state recording part 140 of the hardware logic 100, and monitors the state information of the kernel software modules 20a to 20n to record the same in corresponding fields of the state recording part 140. Herein it is required to previously set up the determination of the record fields and their sizes of the state recording part 140 at the initialization of the system. Therefore, in the execution of the kernel software modules 20a to 20n in the OS 10, the state recording part 140 records the present state of the kernel software modules 20a to 20n in previously set fields according to the sizes of the fields.

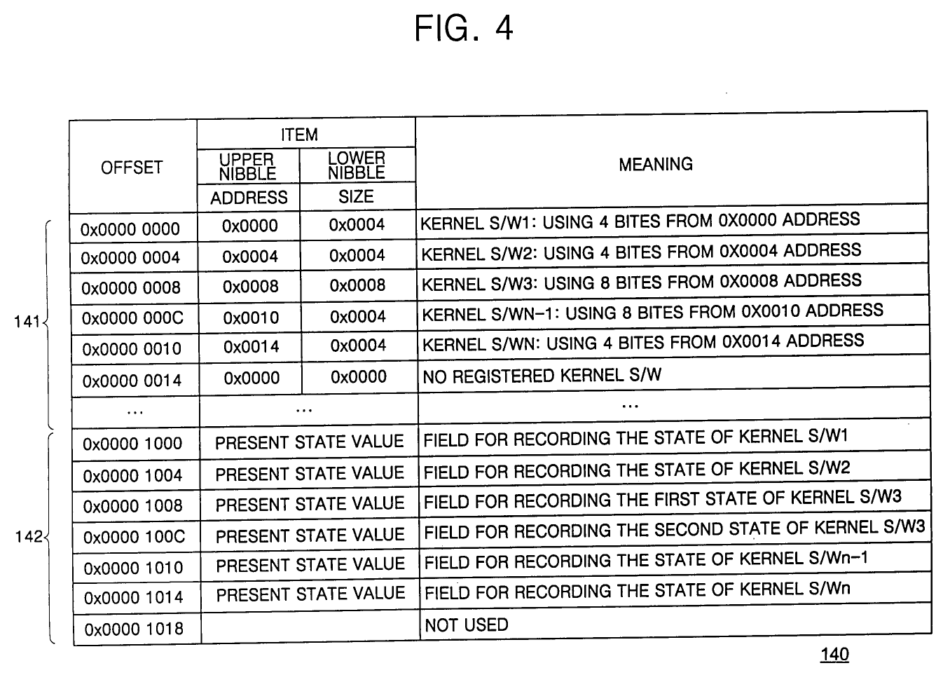

The state recording part 140 of the hardware logic 100 is a type of memory for recording the state information of the kernel software modules 20a to 20n of the OS 10 provided by the state record setting part 50 into the fields allocated by the state record setting part 50 of the OS 10. The information recorded in the state recording part 140 includes offset address, state information address in which the state information of the kernel software modules 20a to 20n are to be recorded, the size information of the state information address and the present state information of the kernel software modules 20a to 20n. The state recording part 140 will be described in detail later in the specification with reference to FIG. 4.

The state inspection requesting part 150 serves to output state monitoring results of the kernel software modules 20a to 20n via the display 110 so that a key input signal for inspecting the present state of the software modules 20a to 20 is provided to the state reading part 130, and may be constituted of a key or keyset. That is, the state inspection requesting part 150 has a user input processing function for inspecting the state information of the kernel software modules 20a to 20n.

When a request signal for the state information inspection to the present kernel software modules 20a to 20c is received from the state inspection requesting part 150, the state reading part 130 interprets or reads the state information of the kernel software modules 20a to 20n of the OS 10 stored in the state recording part 140, and provides the state information to the state output part 120.

The state output part 120 converts the state information of the kernel software modules 20a to 20n from the state reading part 130 into a format, which is easily recognizable by users, and displays the converted state information format via the display 110. Herein the display 110 is a hardware part utilizing a display device such as a character LED (light emitting diode), etc., and may present data in the form of binary or decimal numbers so that a user can easily conceive the state of the kernel software modules 20a to 20n. The display 110 may also present data in the form of text messages by using a display device such as an LCD (liquid crystal display), etc.

As a result, the hardware logic 100 shown in FIG. 3 can be designed, realized and used by using a Field Programmable Gate Array (FPGA), and interfaces the OS 10 via the state recording part 140 of the OS 10 and the state recording part 140 of the hardware logic 100.

The state recording part 140 shown in FIG. 3 will be described in more detail with reference to FIG. 4.

FIG. 4 is a table illustrating a data structure or format stored in a state recording block in FIG. 3.

As shown in FIG. 4, the state recording part 140 is a type of memory range allocated in an I/O (input/output) space so that the state recording part 140 is located in a specific area of the hardware logic 100.

An offset array of the state recording part 140 shown in FIG. 4 means the address of a storage field (i.e., a memory), in which 0x0000 0000 designates the first address. This address field may be generally classified into two fields.

The first field 141 is a field to be recorded with record initialization setting addresses (0x0000 0000 ˜) according to the kernel software modules 20a to 20n, and the second field 142 is a field (0x0000 1000 ˜) to be recorded with present state values according to the kernel software modules 20a to 20n.

In order to outwardly inform the present state of the kernel software modules 20a to 20n in the OS 10, the hardware logic 100 is required to know where a kernel software records its present state information. Such information is to be informed to the hardware logic 100 by the kernel software modules, and the first field 141 is used to inform such information. Herein it is required to record address values and sizes in the first field. For example, in order to store two items in 32 bits, the first field may be divided into 16 bit nibble units (e.g., upper and lower nibbles).

Further, the fields may be allocated with different sizes since the kernel software modules 20a to 20n may have different information to be recorded. That is, the size of the first field depends on the number of the kernel software modules 20a to 20n.

For example, a shown in FIG. 4, if an offset address “0X0000 0000” has an upper nibble (address) “0X0000” and a lower nibble “0X0004”, the state information of the first kernel software module is recorded in “0X0000 1000” address range of the offset address or the second field 142 of the state recording part 140 by using 4 bites from “0X0000” address.

In the meantime, the second field 142 of the state recording part 140 is a space where the kernel software modules 20a to 20n record the present state in designated offsets. The second field 142 is recorded with values suggesting the present state of the software modules 20a to 20n. These values are distinguished according to software modules since they may be different according to the kernel software modules 20a to 20n. That is, the present state values are to be set and recorded according to different code values since the kernel software modules 20a to 20n execute their own functions different from one another. For example, the software modules may be recorded according to hexa values different from one another in order to discriminate the state values different from one another.

The present state values of the kernel software modules 20a to 20n recorded in the second field 142 of the state recording part 140 may include for example address values of I/O ranges to be accessed, major resource type values to be accessed, machine state values of the software modules and so on.

As a result, because present states are different according to the kernel software modules 20a to 20n, it is necessary for the user to discriminate in person output values via the display 110. Accordingly, those values displayed via the display 110 may be presented in the form of binary or decimal numbers or text messages so that the user can easily recognize the state value of the software modules. Those values are format-converted in the state output part 120 as shown in FIG. 3. For example, if the state values of the software modules recorded in the second field of the state recording part 140 are composed in hexa codes, the state output part 120 converts the format of the state values, i.e., converts the hexa codes into binary or decimal numbers or text messages so that they can be presented via the display 110.

Further, all the state values of the kernel software modules 20a to 20n can be displayed simultaneously. Alternatively, the state values of the kernel software modules 20a to 20n may be displayed in a round robin fashion, that is, the state values may be read and displayed in their order whenever the user presses the state inspection requesting part 150 in the form of a key. Then, the ID (identification) information of a corresponding kernel software module and the present state value thereof are displayed so that the user can identify the corresponding software module and its present state value.

Hereinafter a stepwise description will be made about a method for monitoring the software module state of the OS according to the invention corresponding to the operation of the apparatus for monitoring the software module state of the OS in the system using the embedded multitasking OS according to the invention as described above.

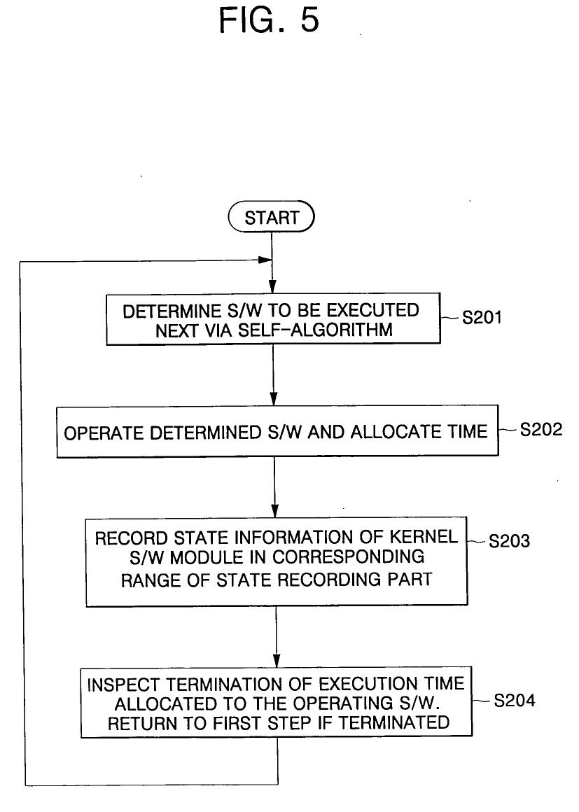

FIG. 5 is a process flowchart illustrating a method for monitoring software module state of an embedded multitasking OS according to the invention in a system using the embedded multitasking OS.

As shown in FIG. 5, a scheduler 30 in an OS 10 determines some of the kernel software modules 20a to 20n to be operated next via self-algorithm (S201).

If the execution times allocated to the software modules 20a to 20c are terminated, the scheduler 30 stops the software modules 20a to 20c, executes those ones of the software modules determined to be operated next, and then allocates execution times to the operating ones of the kernel software modules 20a to 20n (S202).

The operated kernel software modules 20a to 20n record their present state information in corresponding ranges of the state recording part 140 (S203). In order to record the state information of the kernel software modules 20a to 20n in the corresponding ranges of the state recording part 140, it is necessary to determine ranges for recording the state information and range sizes as shown in FIG. 4 at the initialization of the kernel software modules 20a to 20n. A method for determining the state information recording ranges and the range sizes will be described later.

After the state information of the corresponding kernel software modules 20a to 20n are recorded, the scheduler 30 judges whether the execution times allocated to the currently operating kernel software modules 20a to 20n are terminated, and if the allocated times are terminated, determines which of the kernel software modules 20a to 20n shall be operated, and then repeats the foregoing process (S204).

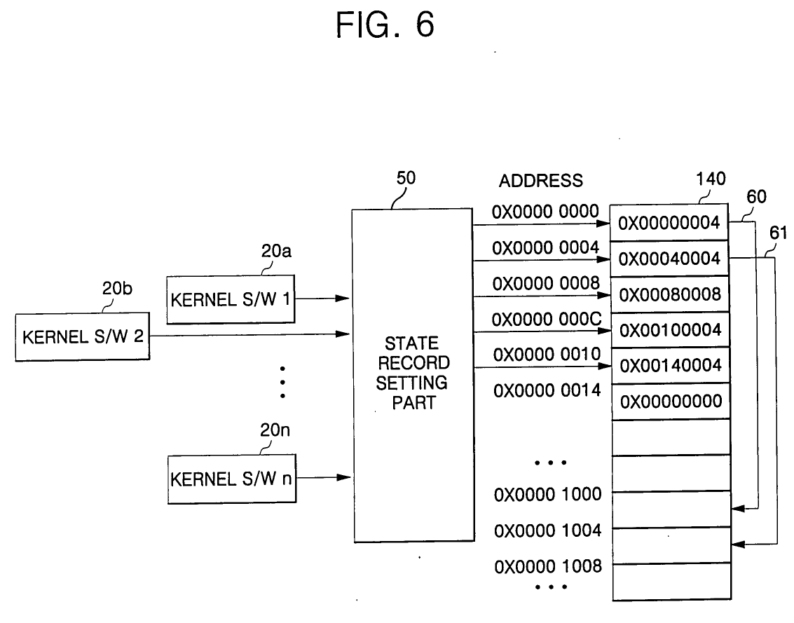

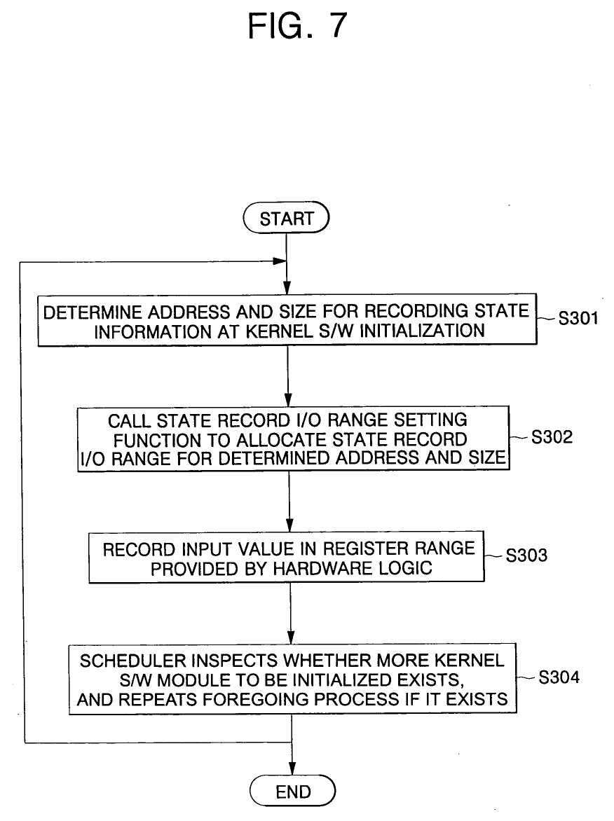

A method executed by the state record setting part 50 shown in FIG. 3 for determining record ranges (addresses) and address sizes in order to record the state information of the operating ones of the kernel software modules 20a to 20n will be explained with reference to FIGS. 6 and 7.

FIG. 6 is a block diagram illustrating data flow for determining addresses and sizes according to which the kernel software modules shown in FIG. 4 record their state information in the state recording part, FIG. 7 is a process flowchart illustrating a method for determining addresses and sizes according to which the kernel software modules of the invention record their state information in the state recording part.

A process for determining addresses and address sizes according to which the kernel software modules 20a to 20n record their state information in the state recording part 130 is necessarily performed in the initialization of the kernel software modules 20a to 20n, and the state information may not be precisely read or displayed in the hardware logic 100 without correct execution of this process.

First, at the initialization of the kernel software modules, the state record setting part 50 of the OS 10 determines addresses according to which the state information of the kernel software modules 20a to 20n are recorded (S301) and the sizes of ranges for recording to state information.

The state record setting part 50 calls a related function or a state record setting function in order to record the determined addresses and the size information of the state information recording ranges in the state recording part 140 (S302).

The state record setting function of the state record setting part 50 records the state information from the kernel software modules 20a to 20n in corresponding ranges of the second field 142 of the state recording part 140 as in FIG. 6 (S303). The recorded values indicate the state information recording range of an actual software module of the second field 142 of the state recording part 140. That is, the reference numeral “60” shown in FIG. 6 indicates an actual range where the state information of a kernel software module is recorded, in which the state information corresponds to “0X00000004” as an upper nibble value (address) and a lower nibble value (size) in the first field of the state recording part 140. The reference numeral “61” indicates an actual range where the state information of a kernel software module is recorded, in which the state information corresponds to “0X00040004” as an upper nibble value (address) and a lower nibble (record range size).

As the initialization of one corresponding kernel software module is initialized to complete the state information record initial setup to record the state information of a kernel software module as well as the state information recording, the scheduler 30 inspects whether the kernel software modules 20a to 20c include any software module to be initialized next, and if the kernel software modules 20a to 20c include a software module to be initialized, repeats a process of the same as above (S304).

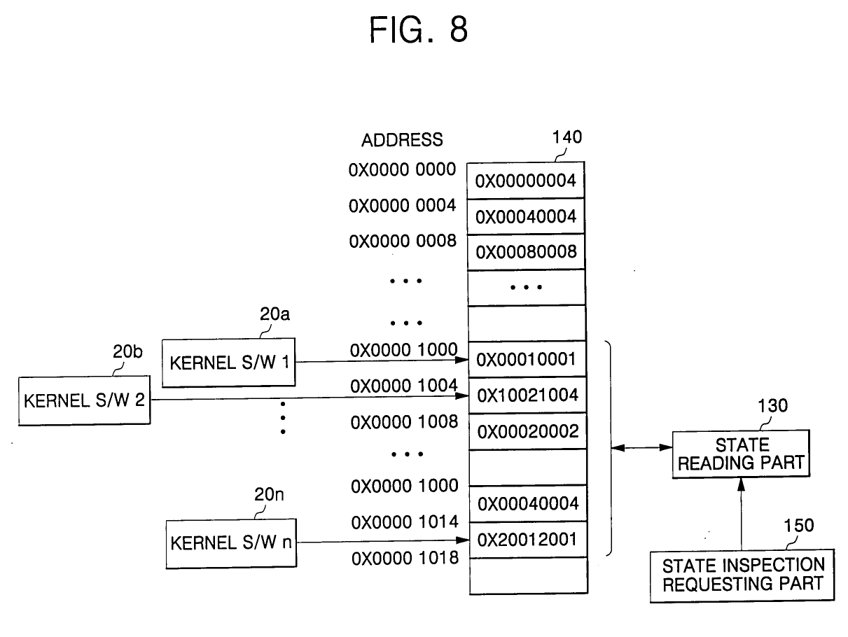

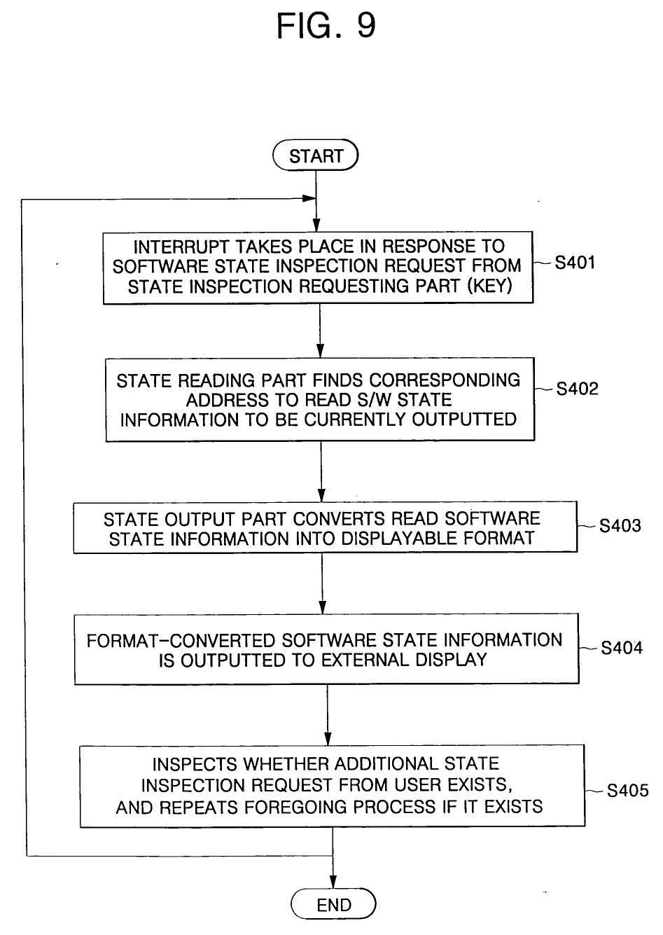

After the state information of the kernel software modules 20a to 20n is recorded in the state recording part 140, the recorded state information of the kernel software modules 20a to 20n are read and presented via the display 110 in response to a request from a user, which will be explained stepwise with reference to FIGS. 8 and 9.

FIG. 8 is a block diagram illustrating data flow in the hardware logic shown in FIG. 4 in which the kernel software modules output the state values recorded in the state recording part to the external display in response to a request from a user, FIG. 9 is a process flowchart illustrating a method for outputting the software state values recorded in the state recording part of the hardware logic shown in FIG. 4 to the external display according to the data flow shown in FIG. 8 in response to the request from the user.

First, when the user judges that the present system has an abnormal state, he/she inputs a state inspection request signal via the state inspection requesting part 150. Then, the state reading part 130 generates an interrupt associated with the state inspection request (S401). Herein, the state inspection requesting part 150 means a hardware button (key).

In response to the input state inspection requesting signal from the state inspection request part 150, the state reading part 130 selects one or more from the kernel software modules 20a to 20n so that the state information of the selected software module(s) is presented via the external display 110. This process can determine the kernel software modules 20a to 20n for example in a round robin fashion.

If currently used ones of kernel software modules 20a to 20c are recorded according to the above process whenever state inspection requests are received, next ones of the kernel software modules 20a to 20c can be used when a next inspection request is received. That is, this technique sequentially reads the state information for the kernel software modules 20a to 20n recorded in the state recording part 140 whenever the user presses the state inspection request key. Alternatively, when the state inspection requesting part 150 inputs a request signal in response to key input, all the state information of the kernel software modules 20a to 20n recorded in the state recording part 140 may be sequentially read and outputted.

In this way, the state reading part 130 finds addresses corresponding to some of the kernel software modules 20a to 20n which are outputted at present, reads the state information of the software modules 20a to 20n stored in the corresponding addresses, and sends the found state information to the state output part 120 shown in FIG. 3 (S402).

The state output part 120 converts the state information of the kernel software modules 20a to 20n read by the state reading part 130 into a specific format that is easily recognizable by the user (S403). In the format conversion, if the state information of the kernel software modules 20a to 20n is stored in the form of hexa codes in the state recording part 140, hexa code values may be converted into binary or decimal numbers or into a text message format corresponding to the state information.

Then, the format-converted kernel state information is presented via the display 110 shown in FIG. 3 (S404). Herein available examples of the display 100 may include a character LED and LED for displaying the format-converted state information values for example binary and decimal numbers and text messages.

Next, upon receiving a further state information output request via the state inspection requesting part 150 from the user, the state information of the kernel software modules 20a to 20n is read and presented via the display 110 through the foregoing process in a round robin fashion (S405).

Alternatively, it is also apparent to those skilled in the art from the disclosure above that the state information of all the kernel software modules 20a to 20n recorded in the state recording part 140 may be sequentially read and presented via the display 110 when the user inputs a state inspection request signal by using the state inspection request key.

The foregoing process associated with software (as in FIGS. 5 and 7) is performed 11 independent from the process associated with hardware (as in FIG. 9). As a consequence, in case that the OS 10 has an uncommon state because of abnormal operation of a specific one of the kernel software modules 20a to 20n or system resources are monopolized by a specific one of the kernel software modules 20a to 20n, the present state can be inspected at any time via the hardware logic 140.

Such tracking is enabled because the state recording part 140 shown in FIG. 3 constantly keeps the content recorded last by the specific one of the kernel software modules 20a to 20n.

In the event of such a serious situation, the state information presents the final situation of the specific one of the kernel software modules 20a to 20n via the external display 110, and thus it is easy to approach a solution.

As a result, the apparatus and method for monitoring the software module state of the embedded multitasking OS in a system using the OS records the state information of the software modules of the OS in the hardware logic, reads the recorded state information of the software modules via the hardware logic, and displays or presents the read state information.

That is, the state information of the software modules of the OS is recorded sequentially in the state recording range of the hardware logic and then sequentially read via the hardware logic in response to a state information inspection request from a user so that state information of the software modules of the OS can be monitored and confirmed independent from the operation of the software modules of the OS.

The apparatus and method for monitoring the software module state of the embedded multitasking OS in a system using the embedded multitasking OS according to the invention sequentially records the state information of the software modules in the state recording range of the hardware logic, sequentially reads the state information of the software modules from the state recording range, and displays the state information so that the user can easily recognize the same. As a result, the state information of the software modules can be monitored and inspected independent from the operation of the software modules of the OS, and thus the state of the software modules or the OS can be inspected in any exceptional software-associated situations.

In practice, many systems suffer from such exceptional situations and heavy efforts have been made to solve such problems. The present invention can overcome such problems by providing the software and hardware design by which software and hardware not influence each other's operation.

Furthermore, in the prior art, it is difficult to find problems when the OS is in the above severe situation or hang, and a large amount of time and man power is required to solve such problems. However, the present invention can be applied to initial system design to save such waste.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

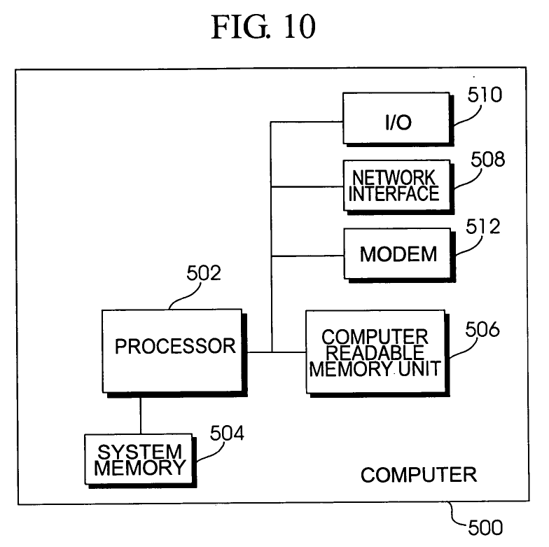

An example of a computer, but not limited to this example of the computer, that can read computer readable media that includes computer-executable instructions of the present invention is shown in FIG. 10. The computer 500 includes a processor 502 that controls the computer 500. The processor 502 uses the system memory 504 and a computer readable memory device 506 that includes certain computer readable recording media. A system bus connects the processor 502 to a network interface 508, modem 512 or other interface that accommodates a connection to another computer or network such as the Internet. The system bus may also include an input and output interface 510 that accommodates connection to a variety of other devices.

While the invention has been particularly shown and described with reference to the preferred embodiments thereof, it will be understood by those skilled in the art that the foregoing and other changes in form and details may be made therein without departing from the spirit and scope of the invention.

1. An apparatus for monitoring software modules in a multitasking operating system in a system using said multitasking operating system, comprising a hardware logic interfaced with said operating system, wherein said hardware logic comprises:
a first unit determining a record range for recording state information of said software modules of said operating system therein and said size of said record range, and sequentially recording said state information of an operating software module in a corresponding range; and
a second unit reading and outputting said recorded state information of said software module in response to a state information request event.

2. The method for monitoring software modules according to claim 1, wherein said operating system determines a recording range address, in which said state information of said respective software modules will be recorded at said initialization of said software modules, and said size of corresponding address, and includes a state information record setting module for recording said determined address and said size of said software state information to be recorded in a state information recording range of said hardware logic.

3. The apparatus for monitoring software modules according to claim 1, wherein said operating system determines a software module to be operated next from said software modules, upon termination of time allocated to a currently operating software module, operates said determined software module, and allocates an operating time to said determined software module in order to control said schedule of said respective software modules to accommodate an operating software module to record its state information in a software state information recording range of said hardware logic.

4. The apparatus for monitoring software modules according to claim 3, wherein said currently operating software module records its state information, which is operated last in an execution time allocated to said currently operating software module by said scheduling module, in a state information record range of said hardware logic allocated to said currently operating software module.

5. The apparatus for monitoring software modules according to claim 1, wherein said hardware logic comprises:
a state information recording part for recording said state information of a software module of said operating system, which is operated based upon said software module state recording range address determined at said initialization of said respective software modules of said operating system and said size information of said corresponding address, in a corresponding range;
a state information requesting part providing a key input signal for inspecting said state information of said software modules of said operating system recorded in said state information recording part;
a state information reading part for reading said state information of said respective software module recorded in said state information recording part and outputting said read state information of said software modules in said form of displayable data upon receiving a state information inspecting request signal from said state information requesting part; and
a display presenting said data corresponding to said output state information of said software modules from said state information reading part.

6. The apparatus for monitoring software modules according to claim 5, wherein said state information recording part includes:
a first recording field for recording said address, in which said state information of said respective software modules of said operating system are to be recorded, and said size information about said state information of said respective software modules corresponding to said address; and
a second recording field for recording said state information of a corresponding software module according said size information about said state information of said respective software modules of said operating system recorded in said first recording field.

7. The apparatus for monitoring software modules according to claim 5, wherein said state information reading part includes a format converting part for converting said state information of a software module read from said state information recording part in said format of displayable data that is easily conceivable by a user.

8. The apparatus for monitoring software modules according to claim 1, wherein said state information reading part sequentially reads said state information of said respective software modules recorded in said information recording part to present said state information of all of said software modules via said display in response to said request signal from said state information requesting part.

9. The apparatus for monitoring software modules according to claim 1, wherein said hardware logic is realized in said form of a Field Programmable Gate Array.

10. The apparatus for monitoring software modules according to claim 1, wherein said hardware logic state information request event includes at least one selected from a group consisting of a state information request event by a user, an error event of an operating software module and a termination event of an operating software.

11. The apparatus for monitoring software modules according to claim 10, wherein said hardware logic records an operating state information at said occurrence time of an error in a corresponding range in response to said error event of a currently operating software module.

12. An apparatus for monitoring software modules in a multitasking operating system in a system using said multitasking operating system, comprising:
an operating system including software modules executing different operations, said operating system determining a recording range address for recording state information according to said software modules and said size of said state information recording range, and generating said size information of said determined address and said state information; and
a hardware logic interfaced with said operating system for recording an address, in which state information according to software modules created from said operating system is recorded, and size information for recording said state information in a first range, and sequentially recording said present state information of an operating software module of said operating system in a second range corresponding to said address and said state information size information, reading said recorded state information of said software modules, converting said state information into a displayable format, and presenting said converted state information of said software modules via a display in response to a state information request event.

13. The apparatus for monitoring software modules according to claim 12, wherein said operating system comprises:
a plurality of software modules for operating different operations;
a scheduling module for allocating executing times to said software modules and controlling said execution of said software modules according to the allocated times; and
a state information record setting part for determining a record range address, in which said state information according to said software modules is recorded, and the size of said corresponding address at the initialization of said software modules, interfacing said determined address, the size value about said software state information to be recorded and said present state information of said software modules to said hardware logic.

14. The apparatus for monitoring software modules according to claim 12, wherein said hardware logic comprises:
a state information recording part for recording said state information of a software module of said operating system, which is operated based upon said software module state recording range address determined at said initialization of said respective software modules of said operating system and said size information of said corresponding address, in a corresponding range;
a state information requesting part for providing a key input signal for inspecting said state information of said software modules of said operating system recorded in said state information recording part;
a state information reading part for reading said state information of said respective software module recorded in said state information recording part and outputting said read state information of said software modules in said form of displayable data upon receiving a state information inspecting request signal from said state information requesting part; and
a display for presenting said data corresponding to said output state information of said software modules from said state information reading part.

15. The apparatus for monitoring software modules according to claim 12, wherein said hardware logic state information request event includes at least one selected from a group consisting of a state information request event by a user, an error event of an operating software module and a termination event of an operating software.

16. The apparatus for monitoring software modules according to claim 15, wherein said hardware logic records an operating state information at said occurrence time of an error in a corresponding range in response to said error event of a currently operating software module.

17. An apparatus for monitoring software modules in a multitasking operating system in a system using said multitasking operating system, comprising:
a state information recording part for recording said state information of said software modules of said operating system in a corresponding range according to a software recording range address determined at said initialization of said software modules of said operating system and said size of a corresponding address;
a state information requesting part for providing a key input signal for inspecting said state information of said software modules of said operating system recorded in said state information recording part;
a state information reading part for reading said state information of said respective software modules recorded in said state information recording part and outputting said read state information of said software modules in said form of displayable data upon receiving a state information inspecting request signal from said state information requesting part; and
a display for presenting said data corresponding to said output state information of said software modules from said state information reading part.

18. The apparatus for monitoring software modules according to claim 17, wherein said state information recording part includes:
a first recording field for recording said address, in which said state information of said respective software modules of said operating system are to be recorded, and said size information about said state information of said respective software modules corresponding to said address; and
a second recording field for recording said state information of a corresponding software module according said size information about said state information of said respective software modules of said operating system recorded in said first recording field.

19. A method for monitoring software modules in a multitasking Operating System in a system using said multitasking operating system, said method comprising said following steps of:
determining a record range for recording said state information of said software modules of said operating system therein and said size of said record range, and sequentially recording said state information of an operating software module in a corresponding range; and
when a state information request event occurs, reading and outputting said recorded state information of said software module.

20. The method for monitoring software modules according to claim 19, wherein said recording step comprises:
recording an address and said size information about said state information of said software modules of said operating system in a first recording field, said state information of said software modules being recorded according to said address and said size information corresponding to said address; and
recording said state information of a corresponding software module in a second recording field based upon said size information about said state information of said software modules recorded in said first recording field.

21. A method for monitoring software modules in a multitasking operating system in a system using said multitasking operating system, said method comprising said steps of:
recording said state information of said software modules of said operating system in a corresponding range according to a software recording range address determined at said initialization of said software modules of said operating system and said size of a corresponding address;
upon receiving a key input signal for inspecting said state information of said software modules of said operating system, reading said state information of said respective software modules recorded in said state information recording part and outputting said read state information of said software modules in said form of displayable data; and
presenting said output data corresponding to said state information of said software modules.

22. The method for monitoring software modules according to claim 21, wherein said step of recording said state information comprises:
recording said address, in which said state information of said respective software modules of said operating system are to be recorded, and said size information about said state information of said respective software modules corresponding to said address in a first field; and
recording said state information of a corresponding software module in a second field according said size information about said state information of said respective software modules of said operating system recorded in said first recording field.

23. A computer-readable medium having computer-executable instructions for performing a method of monitoring software modules in a multitasking operating system in a system using said multitasking operating system, comprising a hardware logic interfaced with said operating system, comprising:
determining a record range for recording state information of said software modules of said operating system therein and said size of said record range, and sequentially recording said state information of an operating software module in a corresponding range; and
reading and outputting said recorded state information of said software module in response to a state information request event.
